(19) United States
(12) Patent Application Publication
(10) Pub. No.: US 2005/0167408 A1
(43) Pub. Date: Aug. 4, 2005

(54) Marking/imprinting means for clothing

(75) Inventors: Anthony J. Gaiotti, Red Bank, NJ (US); Michelle L. Sauer, New York, NY (US)

Correspondence Address: SUGHRUE MION, PLLC, 2100 PENNSYLVANIA AVENUE, N.W., SUITE 800, WASHINGTON, DC, 20037, US

(73) Assignee: ECKO UNLTD.

(21) Appl. No.: 10/765,889

(22) Filed: Jan. 29, 2004

(51) Int. Cl. B23K 26/18

(52) U.S. Cl. 219/121.68

(57) ABSTRACT

An apparatus and method for facilitating a wear pattern on fabric. The apparatus and method include a device being permanently affixed to the fabric. The device causes the wear pattern to become increasingly prominent on the fabric over time as the fabric undergoes normal wear by a consumer.

### BACKGROUND OF THE INVENTION

This invention relates to a method and apparatus for creating a wear pattern of a desired design on a predetermined area of a garment. Such a desired wear pattern is achieved by a textured panel via normal wearing of the garment by the consumer.

At present, there exists a method of creating a wear pattern in the shape of a desired design on a garment. However, this method requires complicated machinery and/or labor intensive steps during the manufacturing process and does not provide long lasting results.

One example of such a method is disclosed in U.S. Pat. No. 5,505,739. In this method, various abrading techniques are required during manufacture to achieve a desired wear pattern on the garment. In particular, an object is inserted into a rear pocket of the garment and the shape of the object is traced over by sandblasting during the manufacturing of the garment. After the sandblasting step, the object is removed from the pocket and manufacturing of the garment is continued with other abrasive and washing steps.

In addition to the labor intensive requirements of the above process, the wear pattern that is created during the manufacture of the garment tends to fade over time as the garment is worn by the consumer. More specifically, over time the garment tends to wear and fade due to normal wear and washing. Thus, the original image of the wear pattern blends into the overall fading of the garment and becomes less noticeable.

### SUMMARY OF THE INVENTION

It is an object of the present invention to provide a method and apparatus for easily creating a desired wear pattern on a fabric. Another object of the present invention is to provide a desired wear pattern that will not fade over time, but will become more prominent over time.

### BRIEF DESCRIPTION OF THE DRAWINGS

FIG. 1 is an exploded view of a device for impressing a wear pattern on the rear pocket of pants;

FIG. 2 illustrates an example of a wear pattern on the pants;

FIG. 3A is a detailed view of a device for impressing the wear pattern on a garment;

FIG. 3B is a cross sectional view of the device in FIG. 3A; and

FIG. 4 is an exploded view of a device for impressing a wear pattern on the back of a jacket.

### DETAILED DESCRIPTION OF THE INVENTION

The present invention is directed to a device that creates a desired pattern on a garment. In particular, the device marks or impresses upon the garment in order to wear out a pattern on the garment. The device marks or impresses upon the garment during the normal wearing of the garment by a consumer, and thus, the wear pattern becomes increasingly prominent over a period of time.

Many factors influence the best mode of the present invention. In particular, four factors are considered: garment type, fabric of garment, location of marking/impressing means, and material of marking/impressing means.

The means for impressing the wear pattern may be formed of any material, and the choice of the material will depend on the type of fabric forming the garment, as well as the placement of the desired wear pattern on the garment. For instance, the means for impressing a wear pattern may be formed of foam, metal, plastic, wood, cardboard, fabric, etc. Also, for instance, the type of fabric forming the garment may be denim, canvas, twill, fleece, printed fabric, etc. In addition, the type of garment may include pants, jackets, shirts, etc., and thus, the impressing means may be affixed to any number of locations, including elbows, knees, backs, etc. of the chosen garment. Thus, the effectiveness of the means for impressing depends on the combination of the chosen material for the impressing means, the type of garment, the garment fabric, and the location of the impressing means on the garment.

While an unlimited combination of garment, fabric, material and location is contemplated, the following example refers to the use of an embroidered impressing means on a rear pocket of denim pants. However, as mentioned above, the present invention is certainly not limited to this example.

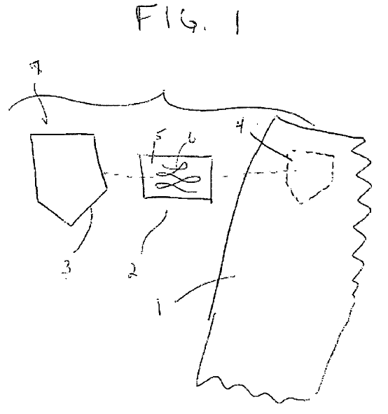

Referring to FIG. 1, a device 2 for impressing a wear pattern on the rear pocket of pants 1 is illustrated. In this example, the pants include at least one rear pocket. At the interior of the pocket, a means 2 for impressing a wear pattern is permanently affixed. The means 2 for impressing the wear pattern may be permanently affixed to either surface of the interior of the pocket. That is, the means for impressing 2 may be affixed to the back surface 4 of the pants or to the interior side 3 of the pocket fabric 7.

In this particular example, the marking/impressing means is a panel 5 embroidered with the desired design 6. The panel 5 is then sewn into the garment—either directly to the pants 1 or to the interior side 3 of the pocket fabric 7. Then the pocket fabric 7 is sewn to the pants 1, so that the embroidered panel 2 is hidden from view and only visible when one views the inside of the pocket. After the embroidered panel 2 is affixed to the pants 1, the pants 1 are hand brushed or sandblasted, and then washed, so that the desired design begins to appear on the rear pant pocket.

Once the consumer begins to wear the pants, the desired design becomes more prominent with normal wear. Thus, over time, the desired design increases in prominence as opposed to the prior art wherein the design decreases in prominence because there is no manner for continually impressing the design on the fabric after the manufacturing process.

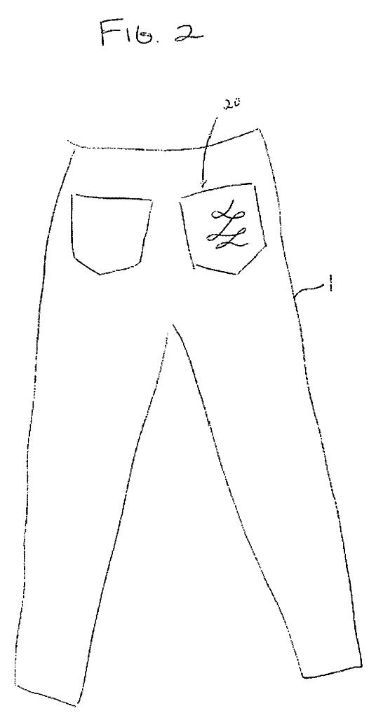

FIG. 2 illustrates an example of the pants after the desired design 6 has been impressed upon the rear pocket 20. As mentioned above, normal wear of the pants causes the wear pattern to become increasingly prominent over time.

In the example discussed above, the embroidered panel 2 is sewn to the garment or pocket fabric 7 to achieve a permanently affixed state. However, the marking/impressing means can be affixed to the garment in other manners to achieve this permanent attachment.

For example, the marking/impressing means could be glued to the fabric, tacked via rivets, or attached via snaps. As long as the marking/impressing means is prevented from slipping out of position during normal wear and wash, the permanently attached state is achieved for purposes of this invention. No effort should be required by the consumer to maintain the affixed state.

In the above example having a rear pocket 20, the garment includes fabric having at least two separate portions 3, 4 for forming the pocket. The means for impressing 2 is permanently affixed to one of the first and second portions 3, 4 of the fabric, for impressing the wear pattern on the other of the first and second portions 3, 4 of the fabric. In this particular example (see FIG. 1), the means for impressing is disposed between the first and second portions 3, 4 of the fabric. With this arrangement, the impressing means is disposed in an interior portion of the pocket so that it is not visible unless one is viewing the inside of the pocket.

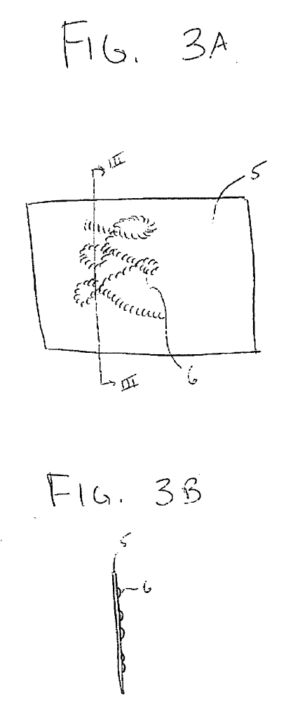

Referring to FIGS. 3A and 3B, the embroidered panel is shown in an enlarged view. In this example, embroidery is used to create the wear pattern. The raised surface of the embroidery rubs against the interior surface of the pocket fabric, thereby creating the desired wear pattern on the exterior surface of the pocket fabric, as illustrated in FIG. 2.

Of course, as mentioned above, the means for impressing a wear pattern is not limited to the embroidered panel. A plastic panel, for instance, may include a raised surface corresponding to a desired pattern. The choice of such material, being either fabric, plastic, metal, wood, or other material, will depend upon the comfort level of the consumer and the location of the panel. Moreover, the height of the raised surface correlates to the material of the garment, as well as location of the panel, since certain areas of the garment will experience more rubbing type of wear than others. For instance, the knee portion of pants may experience more rubbing than a back portion of a jacket, and thus, the back portion of a jacket would require a raised surface that has more height than would a knee portion in order to obtain a desired prominence for the wear pattern.

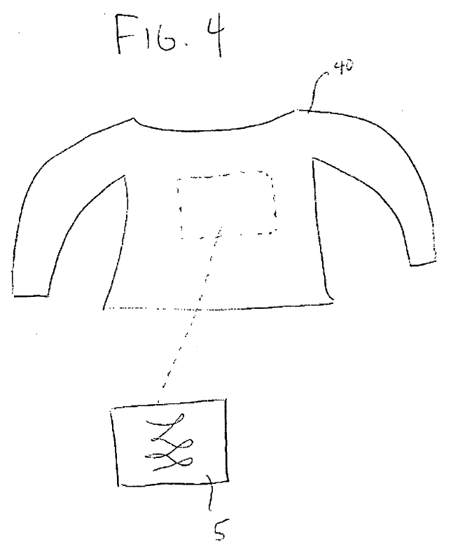

As illustrated in FIG. 4, the panel 5 may be located on the back portion of a shirt 40 or jacket. In particular, the panel 5 should be located on the interior side of the shirt or jacket so that it is not visible when the garment is being worn. The pattern becomes more visible over time due to the consumer's normal wear of the shirt or jacket. For instance, as the consumer leans back against a chair or other surface, or during normal movement of the arms, the shirt or jacket rubs against the consumer's back thereby facilitating the creation of the wear pattern by the impressing means.

While the present invention has been described in detail with respect to the foregoing examples of denim pants with an embroidered panel and an upper body garment having a panel, it is appreciated that other variations of the present invention may be desired without departing from the scope of the claims.

1. An apparatus for facilitating a wear pattern on a fabric, in combination with said fabric, comprising:
means for impressing a wear pattern, said means for impressing being permanently affixed to said fabric.

2. The apparatus according to claim 1, wherein said means for impressing is an embroidered panel.

3. The apparatus according to claim 1, wherein said means for impressing is a wood panel, having raised portions.

4. The apparatus according to claim 1, wherein said means for impressing is a metal panel, having raised portions.

5. The apparatus according to claim 1, wherein said means for impressing is a plastic panel, having raised portions.

6. The apparatus according to claim 1, wherein said fabric comprises at least two separate portions, wherein said means for impressing is permanently affixed to a first portion of said fabric, for impressing the wear pattern on a second portion of said fabric.

7. The apparatus according to claim 6, wherein said means for impressing is disposed between said first and second portions of said fabric.

8. The apparatus according to claim 1, wherein said fabric forms a pocket on a garment, said means for impressing is disposed in an interior portion of said pocket, so as to be permanently affixed to the interior portion of said pocket, for creating a wear pattern on an exterior portion of said pocket.

9. A method for creating a wear pattern on a garment to be worn by a consumer, wherein said garment includes a fabric having an interior side and an exterior side, comprising:
providing a means for impressing a wear pattern on an exterior side of said fabric;
permanently affixing said means for impressing to the interior side of said fabric; and
wearing said garment under normal wear conditions, which thereby causes said means for impressing to rub against the interior side of said fabric so as to create a wear pattern on the exterior side of said fabric.

10. The method according to claim 9, wherein said means for impressing the wear pattern is an embroidered panel.

11. The method according to claim 9, further comprising, before said wearing step:
abrading the fabric, by handbrushing or sandblasting, on the exterior side of said fabric opposite from the interior side having said means for impressing; and
washing the garment.

12. A garment, comprising:
a fabric having an interior and exterior side; and
a design panel permanently affixed to the interior side of said fabric,
wherein said design panel is capable of creating a wear pattern on the exterior side of said fabric when the garment is worn under normal conditions by a consumer.

13. The garment according to claim 12, wherein said design panel is an embroidered panel.

14. The garment according to claim 12, wherein said interior side of said fabric forms a rear pocket on the garment, so that said design panel is disposed inside said rear pocket.

15. The garment according to claim 12, wherein said design panel is a metal plate having a raised surface in the shape of a predetermined pattern, said raised surface facing toward the exterior side of said fabric for facilitating a wear pattern corresponding to the shape of the predetermined pattern.
